(19) United States
(12) Patent Application Publication
(10) Pub. No.: US 2015/0134423 A1
(43) Pub. Date: May 14, 2015

(54) SYSTEM AND METHOD FOR CREATING, IMPLEMENTING, AND TRACKING STRATEGIC PLANS

(71) Applicant: ForwardMetrics Corp., Encinitas, CA (US)

(72) Inventor: Scott J. Warner, Encinitas, CA (US)

(73) Assignee: ForwardMetrics Corp., Encinitas, CA (US)

(21) Appl. No.: 14/079,501

(22) Filed: Nov. 13, 2013

(51) Int. Cl. G06Q 10/06

(52) U.S. Cl. CPC G06Q 10/0637
USPC 705/7.36

(57) ABSTRACT

In one aspect, a system may include a receiver configured to receive a message including a hierarchy identifier, an action, and a task indicator. The system may include a task information processor configured to determine a date range for the task and obtain a metric associated with the task. The system may include an action validator configured to identify one or more nodes within the hierarchical plan based at least partially on the location. The action validator is configured to obtain a date range and a metric for the one or more nodes. The action validator is configured to compare the task date range to node date range(s) and to compare the task metric with to node metric(s). The system also includes a hierarchy manager configured to permit the action based at least partially on the comparison of the date ranges and the comparison of the metrics.

### BACKGROUND

1. Field

The present development relates generally to strategic planning, and more specifically to systems and methods for creating, implementing, and tracking strategic plans.

2. Description of Related Technology

Strategic planning can be a helpful tool for organizations. A strategic plan can describe a unified vision along with discrete steps which may be taken to achieve this vision. As the size of an organization grows, the number of goals and steps which may be identified to achieve the goals increases. Furthermore, the goals of a business may be expressed in increasingly complex terms such as aggregations of information that change minute-to-minute (e.g., stock price).

In view of the scale and dynamic nature of both the strategic plan and the metrics by which success can be measured, systems and methods for creating, implementing, and tracking strategic plans are desirable.

### SUMMARY

The devices, systems, and methods of the present disclosure have several features, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments,” one will understand how the features of this disclosure provide several advantages over other strategic planning systems and methods.

In one innovative aspect, a system for strategic planning is provided. The system includes a receiver configured to receive a message including a hierarchy identifier, an action, and a task indicator. The hierarchy identifier indicates a location within a hierarchical plan to take the action while the task indicator identifies a task. The action may include an add, a remove, a move, or an update. The system includes a task information processor configured to determine a date range for the task and obtain a metric associated with the task. The determination and obtaining may be based at least partially on the hierarchy identifier and the task indicator. The system also includes an action validator configured to identify one or more nodes within the hierarchical plan based at least partially on the location. The action validator is also configured to obtain a date range and a metric for the one or more nodes. The action validator is further configured to compare the date range for the task to a date range for the one or more nodes and to compare the metric associated with the task to the metric associated with the one or more nodes. The system also includes a hierarchy manager configured to permit the action based at least partially on the comparison of the date ranges and the comparison of the metrics.

In some implementations, the system may include a memory storing connection information associated with one or more data sources such as the hierarchy plan, another hierarchy plan, a database, a networked information system, an electronic record, or a user interface. The system may include a transmitter configured to transmit a request for one or more values to at least one of the one or more data sources based at least partially on the stored connection information associated with the selected data sources. In some implementations, the receiver is configured to receive a response including the one or more values. A metric communication processor may be included in the system. The metric communication processor may be configured to identify at least one of the one or more data sources from the memory for the metric associated with the task or the metric associated with the one or more nodes, cause the transmitter to transmit a request based at least partially on the identified data source, obtain a response from the receiver, the response including one or more values, and generate the metric associated with the task or the metric associated with the one or more nodes based at least partially on the received one or more values.

The hierarchy manager may be configured to permit the action upon determining the date range for the task is within the date range for the one or more nodes. In some implementations, the metric associated with the one or more nodes includes a growth metric. In such implementations, the hierarchy manager may be configured to permit the action upon determining the metric associated with the one or more nodes in combination with a corresponding growth metric for the task exceeds the growth metric associated with the one or more nodes.

In some implementations, the metric associated with the one or more nodes includes a minimization metric. In such implementations, the hierarchy manager may be configured to permit the action upon determining the metric associated with the one or more nodes in combination with a corresponding minimization metric for the task is less than the minimization metric associated with the one or more nodes.

The one or more nodes may include a node having a path to a root node of the hierarchy plan, the path having a length shorter than a path from the location to the root node. In some implementations, the one or more nodes may include a node having a path to a root of the hierarchy plan, the path having a length greater than a path from the location to the root node.

In some instances of the system, the hierarchy manager is configured to aggregate date ranges for a plurality of the one or more nodes to generate a comparison date range. The hierarchy manager may be configured to aggregate at least one of date ranges for a portion of the one or more nodes to generate a comparison date range or metrics for a portion of the one or more nodes to generate a comparison metric.

In another innovative aspect, a method of strategic planning is provided. The method includes receiving, via a receiver, a hierarchy identifier, an action, and a task indicator. The hierarchy identifier indicates a location within a hierarchical plan to take the action while the task indicator identifies a task. Example actions include an add, a remove, a move, or an update for the task at the location. The method also includes determining, via a processing circuit, a date range for the task based at least partially on the hierarchy identifier and the task indicator. The method further includes obtaining a metric associated with the task from an electronic data source based at least partially on the hierarchy identifier and the task indicator. The method also includes identifying one or more nodes within the hierarchical plan based at least partially on the location. The method includes obtaining a date range and a metric for the one or more nodes. The method further includes comparing the date range for the task to a date range for the one or more nodes. The method also includes comparing the metric associated with the task to a metric associated with the one or more nodes. The method further includes permitting the action based at least partially on the comparison of the date ranges and the comparison of the metrics.

Obtaining the metric for the task or obtaining the metric for the one or more nodes, or both may include identifying a data source for the metric associated with the task or the metric associated with the one or more nodes, transmitting a request to the data source for one or more values, receiving a response including the one or more values, and generating the metric associated with the task or the metric associated with the one or more nodes based at least partially on the received one or more values.

The action may be permitted upon determining the date range for the task is within the date range for the one or more nodes. The metric associated with the one or more nodes may, in some implementations, include a growth metric. In such implementations, the action may be permitted upon determining the metric associated with the one or more nodes in combination with a corresponding growth metric for the task exceeds the growth metric associated with the one or more nodes.

In some implementations, the metric associated with the one or more nodes may include a minimization metric. In such implementations, the action may be permitted upon determining the metric associated with the one or more nodes in combination with a corresponding minimization metric for the task is less than the minimization metric associated with the one or more nodes.

The one or more nodes may include a node having a path to a root node of the hierarchy plan, the path having a length shorter than a path from the location to the root node. The one or more nodes may include a node having a path to a root of the hierarchy plan, the path having a length greater than a path from the location to the root node.

In some implementations, the method may include aggregating date ranges for a plurality of the one or more nodes to generate a comparison date range. Some implementations of the method may include aggregating at least one of date ranges for a portion of the one or more nodes to generate a comparison date range or metrics for a portion of the one or more nodes to generate a comparison metric.

Obtaining a date range and obtaining a metric for a portion of the one or more nodes may be performed in parallel in some implementations of the method. Comparing the date range for the task to a comparison date range for the one or more nodes and comparing the metric associated with the task to a comparison metric associated with the one or more nodes may be performed in parallel.

In a further innovative aspect, a non-transitory computer readable storage medium comprising instructions executable by a processor of a device is provided. The instructions cause the device to receive a hierarchy identifier, an action, and a task indicator, the hierarchy identifier indicating a location within a hierarchical plan to take the action, the task indicator identifying a task. The instructions cause the device to determine a date range for the task based at least partially on the hierarchy identifier and the task indicator. The instructions cause the device to obtain a metric associated with the task based at least partially on the hierarchy identifier and the task indicator. The instructions cause the device to identify one or more nodes within the hierarchical plan based at least partially on the location. The instructions cause the device to obtain a date range and a metric for the one or more nodes. The instructions further cause the device to compare the date range for the task to a date range for the one or more nodes. The instructions also cause the device to compare the metric associated with the task to a metric associated with the one or more nodes. The instructions further cause the device to permit the action based at least partially on the comparison of the date ranges and the comparison of the metrics.

### BRIEF DESCRIPTION OF THE DRAWINGS

These and other features, aspects, and advantages of the invention disclosed herein are described below with reference to the drawings of certain embodiments, which are intended to illustrate and not to limit the invention. Additionally, from figure to figure, the same reference numerals have been used to designate the same components of an illustrated embodiment. The following is a brief description of each of the drawings.

FIG. 1 shows a network diagram including an example of a system for strategic planning.

FIG. 2 shows a functional block diagram of an example of a system for strategic planning.

FIG. 3 shows a block diagram of an example hierarchy.

FIG. 4 shows a process flow diagram of an example method of strategic planning.

FIG. 5 shows a block diagram of an example set of nodes associated with a hierarchy.

FIG. 6 shows a date range diagram for validating the example set of nodes.

FIG. 7 shows a process flow diagram of an example method of dynamically validating the date for an object being added to or updated within a hierarchy.

FIG. 8 shows a process flow diagram of an example method of dynamically validating the metric for an object being added to or updated within a hierarchy.

FIG. 9 shows a process flow diagram of an example method of dynamically validating a node being moved or deleted within a hierarchy.

FIG. 10 illustrates a process flow diagram for an example method of strategic planning.

### DETAILED DESCRIPTION OF CERTAIN EMBODIMENTS

The following description and examples illustrate some exemplary embodiments of the disclosed invention in detail. Those of skill in the art will recognize that there are numerous variations and modifications of this invention that are encompassed by its scope. Accordingly, the description of a certain exemplary embodiment should not be deemed to limit the scope of the present invention. The following description and the accompanying figures, which describe and show the preferred embodiments, are made to demonstrate several possible configurations that a strategy planning system or method that may include various disclosed aspects and features.

Strategic planning systems and methods are described. Strategic planning generally refers to an organization's process of defining its strategy, or direction, and making decisions on allocating its resources to pursue this strategy. A “strategic plan” serves the needs of the organization that creates it. A strategic plan that is overly complex or otherwise a mismatch can produce more harm than good for the organization. This may be true for both the process of creating the strategic plan as well as the execution. The best strategic plan is one that works.

A strategic plan includes goals and strategies. The goals must be consistent with the stakeholder's intent for the strategic plan. For example, a strategic plan including a goal to grow exponentially may sound good, but if the owners do not really want that result then it can be a disastrous strategic plan.

Effective goals tend to be clear, concise, and measurable. For example, a strategic plan may include a goal of achieving annualized revenue run-rate of $24M by Q3 2012. (Q3 2012 GAAP revenue of at least $6M, a 25% increase above Q3 2010).

Like goals, strategies should also be clear, concise, and measurable. Strategies may be assigned to a specific person responsible for execution of the strategy. Strategies are generally the activities which will be followed to achieve the goal.

Example strategies which may be associated with the above example goals, can include: (1) hire three new sales reps, one per quarter. Person responsible: VP of Sales; and (2) implement new hiring process by end of Q2 2010 based on applicant testing to improve sales results of new hires. Person responsible: HR director.

Each goal and strategy should be reviewed for the three main principles: “Is it concise?” “Is it clear?” and “Is it measurable?” For example, example strategy #2 could be made more concise by including a specific time frame for the decision of which testing methodology will be used.

A final step for each strategy is that any person named as being responsible must accept this responsibility. If there are any issues in this area, they may lead to problems later on.

Another example of a strategic plan may include the goal to become known as the best-tasting pizza in a market by year-end. The associated strategy for the goal is to create a taste test competition and publicize a successful outcome by the end of the year.

Some strategic plans can include many goals and multiple levels of strategies in support of each goal. Each level drives the strategic plan down one level of the organization such that every employee knows how his or her job affects each of the high level goals. As the complexity of strategic plans increase, the ability to track and maintain a plan also increases. The features described herein facilitate the creation and maintenance of strategic plans.

Various aspects will now be described with reference to specific forms or embodiments selected for purposes of illustration. It will be appreciated that the spirit and scope of the strategic planning systems and methods disclosed herein is not limited to the selected forms. Moreover, it is to be noted that the figures provided herein are not drawn to any particular proportion or scale, and that many variations can be made to the illustrated embodiments.

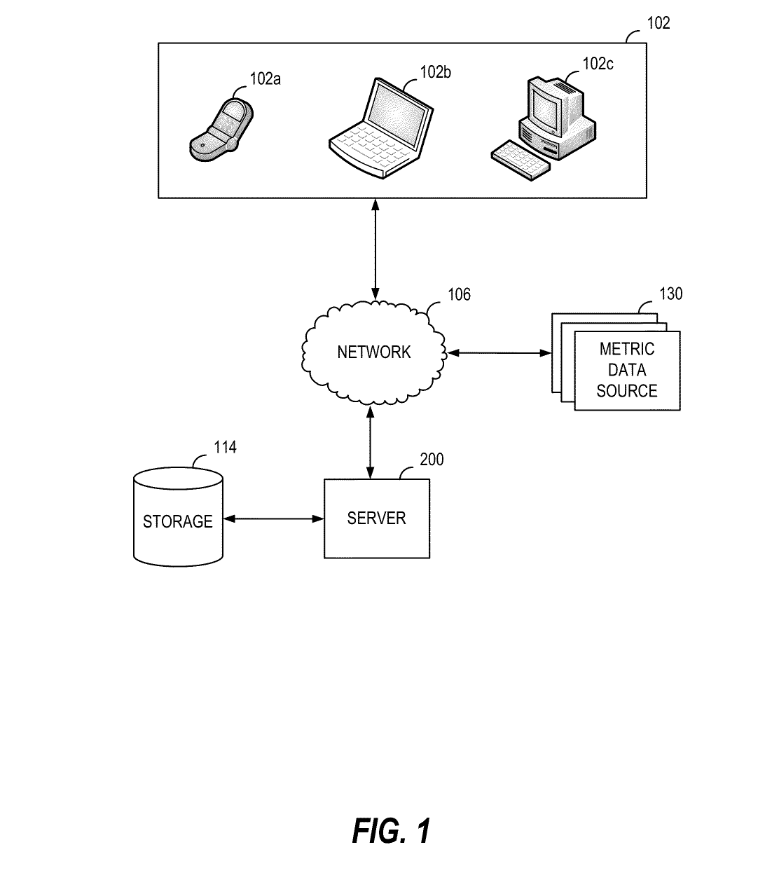

FIG. 1 shows a network diagram including an example of a system for strategic planning. As shown in FIG. 1, the source devices may include, but are not limited to, a mobile phone 102a, a laptop computer 102b, and a desktop computer 102c (collectively and individually referred to hereinafter as “source device 102”). The source device 102 generally includes a communication interface allowing the source device 102 to communicate via a network 106.

The source device 102 may be configured to facilitate strategic planning. The configuration may include one or more software modules executed by a processor included in the source device 102. Accordingly, the source device 102 may receive an input message including information associated with a strategic plan such as information to create a strategic plan, information to alter a strategic plan (e.g., goal or strategy), retrieve a strategic plan (e.g., for viewing), or share a strategic plan.

The network 106 may be a public or private network. The network 106 may include voice over IP (VoIP) networks, enterprise networks, cellular networks, satellite networks, or public switched telephone network (PSTN). The network 106 may be a collection of networks in data communication such as a cellular network including a packet gateway to an IP-based network.

The source device 102 may transmit messages via the network 106 to a strategic planning server 200. The messages may be generated based on the received input message at the source device 102. The strategic planning server 200 is configured to process the messages to provide the requested strategic planning capability (e.g., create, edit, retrieve, share, etc.). The strategic planning server 200 will be described in further detail below.

The strategic planning server 200 may be coupled with a storage device 114. The storage device 114 is configured to provide data storage. For example, the storage device 114 may store information related to one or more strategic plans. As shown in FIG. 1, the storage device 114 is directly coupled with the strategic planning server 200. In some implementations, the storage device 114 may be coupled to the strategic planning server 200 via the network 106. Such implementations are generally referred to as “cloud” storage.

The storage device 114 may also include configuration information for the strategic planning server 200. Such configuration information may include metric data sources. Metric data sources generally refer to data sources which can provide metric information used in one or more strategic plans. Examples of metric data sources include: files located on the strategic planning server (e.g., spreadsheet, text file, other machine readable data source), information services (e.g., a data look-up web service, an Internet site, an FTP site), a monitoring application, a networked smart-device (e.g., smart-meter, smartphone, smart-television), a hierarchy, and/or a user interactive application (e.g., data entry GUI).

The strategic planning server 200 may receive a request for the status of a goal included in a strategic plan. The strategic planning server 200 may obtain the metrics associated with the goal from the storage device 114 along with the metric data source information for the metric. The strategic planning server 200 may then transmit a message to the metric data source 130 based on the obtained metric data source information and receive a current value for the metric. Based on this value, the status of the goal may be determined by the strategic planning server 200.

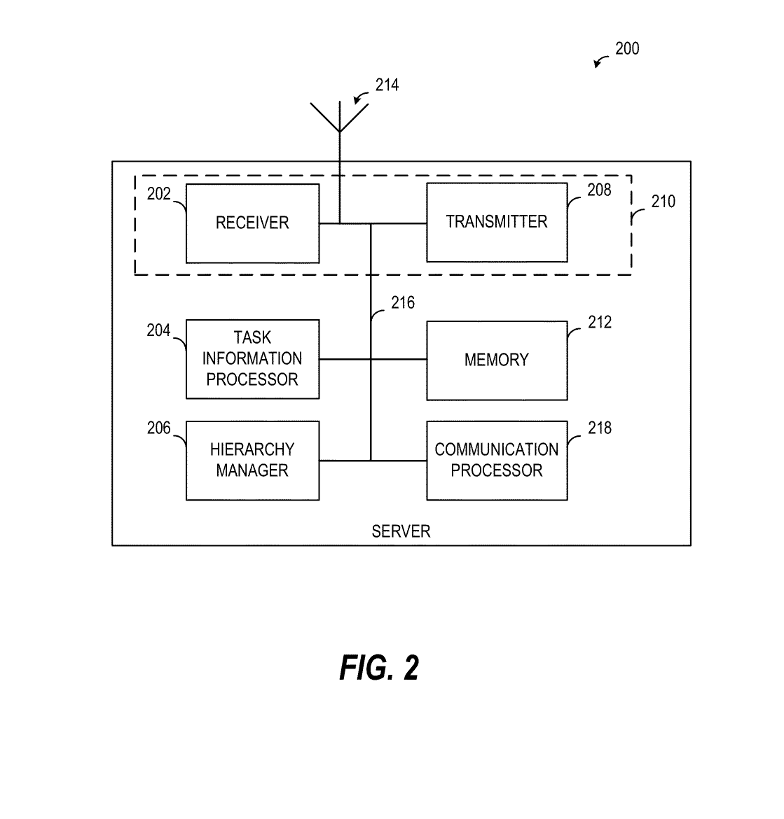

FIG. 2 shows a functional block diagram of an example of a strategic planning server 200 from FIG. 1. The strategic planning server 200 may be configured to perform all or some of the strategic planning activities described herein. It will be understood that the strategic planning server 200 shown in FIG. 2 is an example. The strategic planning server 200 may include other elements which have been omitted to help focus the reader on one example implementation which embodies several innovative strategic planning features.

The strategic planning server 200 includes a receiver 202. The receiver 202 is configured to receive messages. For example, the receiver 202 may be configured to receive messages from the source device 102. The receiver 202 may be configured to receive messages via a wired communication interface or a wireless communication interface. Accordingly, the receiver 202 may include a network interface adapter (e.g., Ethernet adapter or WiFi adapter) and/or a hardware interface adapter (e.g., PCMCIA, USB, or FireWire adapter). It may be desirable for the receiver 202 to obtain messages via a well-defined protocol such as TCP/IP. In such implementations, the receiver 202 may include a message processor for decoding and unpacking message information in accordance with the protocol.

The strategic planning server 200 includes a transmitter 208. The transmitter 208 is configured to transmit messages. For example, the transmitter 208 may be configured to transmit messages to the source device 102. The transmitter 208 may be configured to transmit messages via a wired communication interface or a wireless communication interface. Accordingly, the transmitter 208 may include a network interface adapter (e.g., Ethernet adapter, WiFi adapter, BlueTooth adapter) and/or a hardware interface adapter (e.g., PCMCIA, USB, or FireWire adapter). It may be desirable for the transmitter 208 to send messages via a well-defined protocol such as TCP/IP. In such implementations, the transmitter 208 may include a message processor for decoding and unpacking message information in accordance with the protocol.

As the features of the receiver 202 and the transmitter 208 may overlap, in some implementations, it may be desirable to combine the receiver 202 and the transmitter 208 into a transceiver 210. For example, the transceiver 210 may include the message processor which may be switched from message receiving mode to a message transmission mode to support the above described features of the receiver 202 and the transmitter 208, respectively.

The strategic planning server 200 may include an antenna 214. The antenna 214 may be included to allow the strategic planning server 200 to send and receive wireless communications. The antenna 214 may be configured to provide the received communications to the receiver 202 and transmit messages generated by the transmitter 208.

The strategic planning server 200 includes a task information processor 204. The task information processor 204 is configured to handle messages related to strategic planning tasks. The task information processor 204 may be configured to generate a task input interface. The interface may be, for example, an HTML document including one or more form elements. The transmitter 208 may send the document to a source device where the form elements may be rendered by a web-browser. The receiver 202 may later receive the form elements from the source device along with values for one or more of the form elements. The received information is provided to the task information processor 204. The received information may include a hierarchy identifier, an action, and a task indicator identifying task information. The task information processor 204 may validate the received information.

The task information may include a task identifier (for previously defined tasks), a task start date, a task end date, a task metric, a task owner, a task description, and task security. The task identifier may be used to uniquely identify a given task within the strategic planning server 200. The task information processor 204 may be configured to determine whether a received task identifier is associated with a task known to the system. If not, the task information processor 204 may be configured to provide an error message identifying the invalid task identifier. The task start date and task end date identify the beginning point in time for a task and an ending point in time for a task. The task information processor 204 may be configured to determine whether the date range for the given task is valid. In some implementations, the task information processor 204 may include further validation rules such as to disallow creation of a task with a beginning date prior to the current date. The validation rules may be stored in a memory 212 included in the strategic planning server 200. The task metric may identify a measurable value to determine a completion status for the task. Example task metrics include sales, head count, customer count, customer contacts, cost, a number of orders, stock price, customer satisfaction, market capitalization, revenue per share, and the like. In some implementations, a task metric may be a generated composite value such as a time averaged value.

A communication processor 218 may be included in the strategic planning server 200 to perform the identification, request, and receipt of task metric data. The communication processor 218 may be configured to identify a data source from a catalog of data sources stored in the memory 212 based on the metric included for a task. The communication processor 218 may be configured to generate a request to the data source for the metric data. For example, the data source may be a web-service. The communication processor 218 may prepare a request including the address of the service and request parameters such as requested metric, username, password, user token, and the like. The communication processor 218 may provide the message directly or indirectly to the transmitter 208 for transmission to the data source. The transmitter 208 may further process the request for efficient transmission. The transmitter 208 may be configured to identify a transmission protocol based on the message. In some implementations, the transmitter 208 may perform additional queries to the memory 212 to identify transmission details for the data source.

The communication processor 218 may be configured to identify data sources for node metrics. The identification may be based on the metric type. For example, the memory may store information mapping the metric type to the metric source (e.g., memory location, file location, server location, etc.) as well as supporting information that may be needed to access the metric source (e.g., password, username, authorization token, etc.).

The communication processor 218 may be configured to negotiate and obtain the metric value(s) based at least in part on the obtained metric information. This may include transmitting one or more requests to the metric source based on the obtained metric information. This may also include receiving one or more response messages including the metric value(s). In some implementations, the received response message may include the requested metric value(s) along with additional information. In some implementations, the communication processor 218 is configured to parse the response and provide only the requested metric value(s). In some implementations, the communication processor 218 may parse all metric values included in the response message and store these for future use. In such implementations, the stored values may form a “cache” of metric values which can be consulted prior to transmitting a subsequent request to the data source. If the value is included in the cache and was obtained within an acceptable period of time (e.g., value is not older than 10 minutes), the cached value may be provided rather than requesting the value anew. This has a non-limiting advantage of avoiding the communication with the data source to obtain the metric value.

The receiver 202 may obtain a response including the metric data. The response may be provided to the communication processor 218. The response may include one or more values corresponding to the requested information. If the request was improper (e.g., unknown metric request, request format error, or authentication error), the response may include an error message indicating the fault.

The task information processor 204 may be configured to generate task display data. The task display data may include information to allow the task to be displayed such as via a graphical user interface. The task display data may be generated based on a request for a task. The request may include a task identifier. The task information processor 204 may then obtain task information from the memory 212 based on the task identifier and generate the display data. The task information processor 204 may also receive a device type associated with the device that requested the display data. The device type may also be used by the task information processor 204 to generate the task display data such that the display data is appropriate for the device type. For example, if the device type is a laptop computer, the display and processing capabilities may be higher than the display and processing capabilities of a first generation smartphone. Accordingly, display sets may be stored in the memory 212, each display set indicating appropriate display data for a given device type. The task information processor 204 may obtain the display set for a given request and generate the task display data accordingly.

As described, the task information processor 204 may perform adding a task to a strategic plan, removing a task from a strategic plan, or updating a task within a strategic plan. One desirable feature for the task information processor 204 is the ability to confirm the action is permitted. The permissions for a given action may be based on one or more factors. One factor is the user identifier associated with the action. Users may be categorized into one or more groups. A given group may have permissions for all or a part of a strategic plan. The task information processor 204 may be configured to determine if the user identifier associated with an action is included in a group which is permitted to perform the action for the identified task. If so, the action may be permitted to proceed. If not, the action may be denied.

For example, it may be desirable to permit a manager to only modify a portion of the hierarchy associated with the manager's business unit. Accordingly, if the manager's user identifier is included in a request to update a node outside the manager's business unit, the task information processor 204 may prevent the action. The task information processor 204 may also be configured to manage visibility for the hierarchy based on the user identifier. It may be desirable to prevent certain users from seeing certain actions. For example, consider a cost saving action such as layoffs. It may be desirable to have this action visible to key decision makers rather than publicly viewable by all members of the organization.

Another factor which may be considered for a given task action is the overall strategic plan. As tasks are added, removed, or changed, it is desirable to maintain the integrity of the overall plan. A strategic plan may be a hierarchy including a goal with several strategies and/or actions feeding into the goal. Each node in the hierarchy may be associated with one or more metrics. As such, the addition of a node to the hierarch may affect the overall metric for parent, sibling, and/or child nodes.

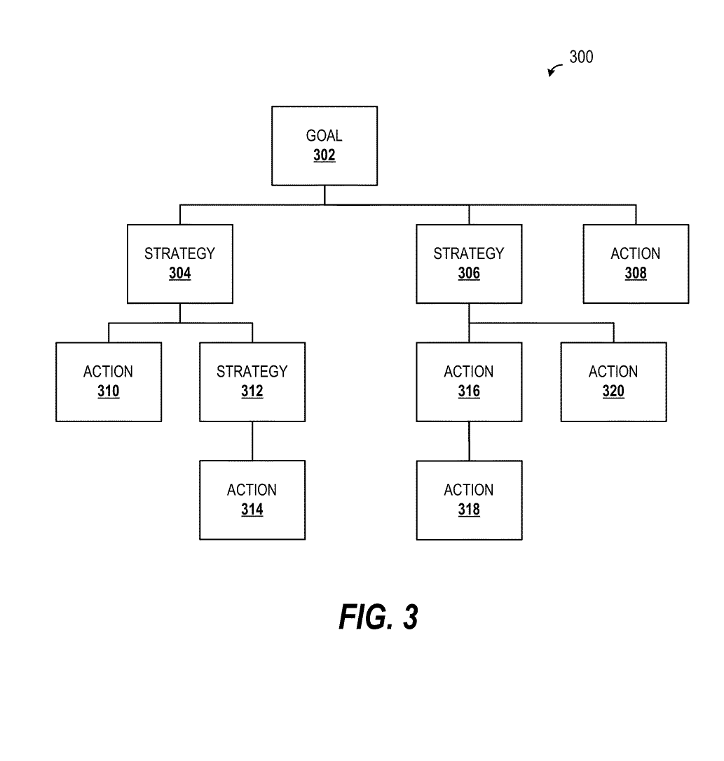

FIG. 3 shows a block diagram of an example hierarchy of tasks. The hierarchy 300 includes a goal 302 at the root of the hierarchy 300. The goal 302 includes three child nodes, a strategy 304, another strategy 306, and an action 308. The strategy 304 shown includes two child nodes, an action 310 and a strategy 312. The strategy 312 includes one child node, an action 314. The strategy 306 includes two child nodes, an action 316 and another action 320. The action 316 includes a child node, an action 318.

The hierarchy 300 illustrates an example of the organizational principles which may be implemented in a strategic plan. A goal (see, e.g., the goal 302) may be the parent node to one or more of a strategy or an action. A strategy (see, e.g., the strategy 304) may be the parent node to one or more other strategies or actions. An action may be the parent node to another action (see, e.g., the action 316). Each element included in the hierarchy 300 may be associated with date information and/or a metric. In some implementations, the data information and/or metric may not be explicitly defined for a node but rather implicitly defined by the aggregation of data information and/or metric values from child nodes.

Returning to FIG. 2, a hierarchy manager 206 may be included in the strategic planning server 200 to maintain the integrity of each hierarchical strategic plan. For example, the hierarchy manager 206 may be configured to receive node information to be added to a hierarchy. The hierarchy manager 206 may validate the processed task information to ensure the task action maintains the hierarchy's integrity. For example, if a task having an end data of December 2099 is added to a node of the hierarchy which is scheduled to end on December 2056, the integrity of the timing for the hierarchy may be compromised by adding the task. The hierarchy manager 206 may collect information for predecessor nodes (e.g., parent, grandparent, etc.) from the proposed task as well as successor nodes (e.g., children, siblings, grandchildren, etc.) from the proposed task. The collected information may be used to determine whether the proposed task action maintains the constraints of the remaining elements.

In the case of removing a task, the hierarchy manager 206 may be configured to ensure the remaining nodes fulfill the specified time and metrics for the remaining nodes in the hierarchy. The hierarchy manager 206 may be configured to obtain one or more metric values for a node as part of the integrity check. Obtaining the metric values may include retrieving a value from a database, retrieving a value from a node within the hierarchy, querying a service, receiving a value, calculating a value from one or more stored values, and the like. To facilitate obtaining the information this process, the hierarchy manager 206 may utilize the communication processor 218.

Each of the elements included in the strategic planning server 200 may be coupled by a bus system 216. The bus system 216 may include a data bus, for example, as well as a power bus, a control signal bus, and a status signal bus in addition to the data bus. The components of the strategic planning server 200 may be coupled together or accept or provide inputs to each other using some other mechanism.

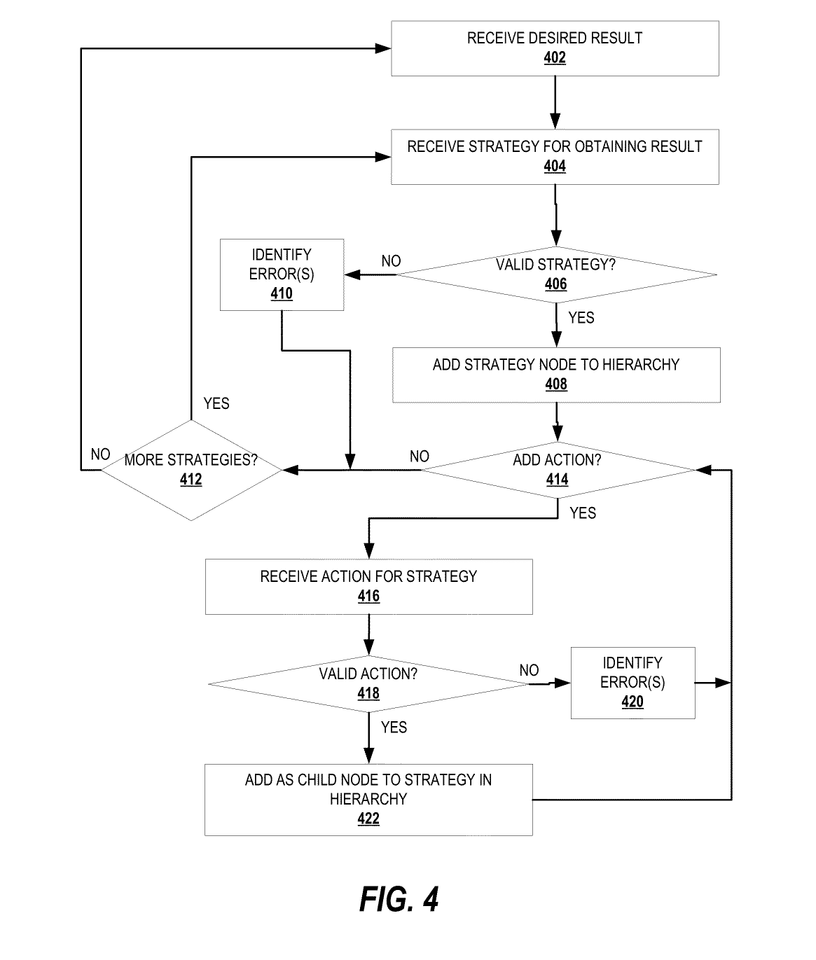

FIG. 4 shows a process flow diagram of an example method of strategic planning. The method shown in FIG. 4 may be implemented in whole or in part by the devices described herein such as the strategic planning server 200.

At block 402, a desired result is received. The desired result may be, for example, total sales at a particular date. The desired result may be received through a user interface such as a graphical user interface. In some implementations, the desired result may be received through an electronic medium such as a message transmission or storage media.

At block 404, a strategy for obtaining the result is received. The strategy may include an activity which furthers the desired result. In the example of increasing sales, one strategy may be to expand the sales force. The strategy may also be associated with a time and/or one or more metrics.

At block 406, the strategy is validated. Validation of the strategy includes comparing the strategy parameters with the desired result. For example, the date information for the strategy may be compared to the desired result date. If the strategy does not have an end date that meets the desired result end date, the strategy may be identified as invalid. Similarly, if the metric of the strategy does not meet the parameters for the desired result, the strategy may be deemed invalid. One example may be a cost metric. If the addition of a child node to a portion of the hierarchy associated with an overall desired cost causes the cost to exceed the desired cost, the addition may be identified as invalid. In some implementations, validation of multiple strategy parameters may be performed in parallel. For example, the validation of the data information along with a metric value may be performed concurrently. This can provide, in some implementations, a system or method which responds to actions more efficiently than implementations where each validation is performed in series.

If the determination at block 406 identifies an invalid strategy, at block 410 the errors are identified. The identification of errors may include generating an error message. The error message may include the validation violation such as the cost metric, the date range, or other condition causing the proposed strategy to be rejected. The identification may include transmitting the errors for presentation to an operator. Once identified, at block 412, a determination is made as to whether more strategies are to be defined. If so, the process continues to block 404 as described above. If not, the process may continue to block 402 to receive another desired result.

Returning to decision block 406, if the proposed strategy is valid, at block 408 strategy is added to the hierarchy. Adding the node to the hierarchy may include creating a record in the database which associates the node with a hierarchy and one or more elements included therein. At decision block 414, a determination is made as to whether an action is to be added for the strategy. If no action is to be added to the strategy, the process continues to block 412 is described above. If decision block 414 determines that an action is to be added, the process continues to block 416.

At block 416, an action is received for the strategy. The action may be similar to those described above such as in reference to FIG. 3. At decision block 418, the action may be validated. Validation of the action may be similar to the validation of the strategy performed at block 406. An action may include a start and/or end date. Determining whether the start and end date is within the desired results start and end date may be performed. An action may also be associated with one or more metrics. If the metric included in the proposed action is within the desired results for the metric within the hierarchy, the action is deemed valid. If deemed valid, the process continues to block 422 where the action is added as child node to the strategy in the hierarchy. The process may then continue to block 414 for receipt of additional actions. Returning to decision block 418, if the action is deemed invalid, at block 420 the errors may be identified. The identification of errors may be similar to the identification of errors performed at block 410. Once identified, the process may continue to block 414 for addition of additional actions.

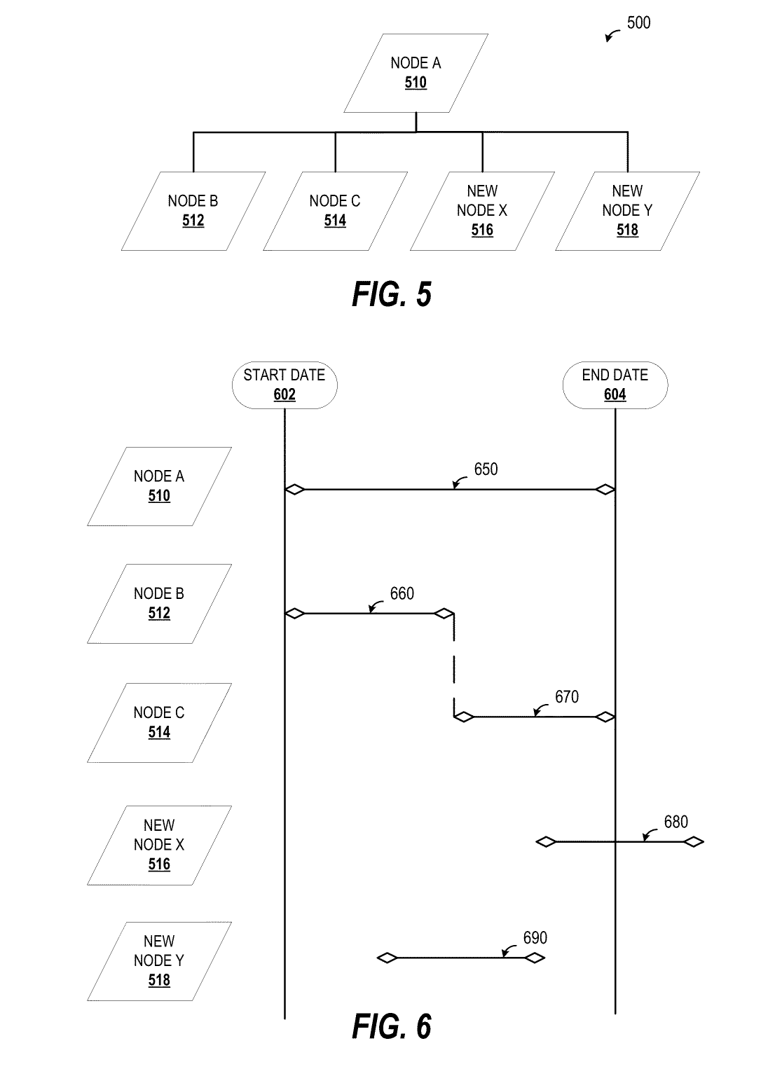

FIG. 5 shows a block diagram of an example set of nodes associated with a hierarchy. FIG. 4 discussed adding strategies and actions to a hierarchy. FIG. 5 provides a generalized portion of a hierarchy. The portion of the hierarchy 500 includes a parent node A 510. The parent node A 510 may be a desired result or a strategy. The portion of the hierarchy 500 also includes a child node B 512 and a child node C 514. The portion of the hierarchy 500 includes the proposed addition of a new node X 516 and a new node Y 518. A determination is made as to whether the new node X 516 and the new node Y 518 may be added to the portion of the hierarchy 500. For example, the determination may be performed in accordance with the process shown in FIG. 4. The determination may be based on the validation of the new nodes (516 and 518) in reference to the nodes included in the portion of the hierarchy 500.

FIG. 6 shows a date range diagram for validating the example set of nodes. Date range validation is one form of determining what may be performed when adding or updating a node within a hierarchy. Node A 510 may be associated with a start date 602 and an end date 604. The start date 602 and the end date 604 may define a period of time 650 for the portion of the hierarchy 500.

Nodes added to the hierarchy beneath node A 510 must fall within the start date 602 and the end date 604 in order to be deemed valid. Node B 512 may begin at the start date 602, and end at some point before the end date 604. Accordingly node B 512 is associated with a time period 660. Node C 514 may be a successor task to node B 512. As shown in FIG. 6, node C 514 begins after the completion of node B 512 and ends at the end date 604. A period of time 670 for node C 514 does not extend beyond the period of time 650 for its parent node, node A 510.

New node X 516 may be associated with a time period 680 that extends beyond the end date 604. Accordingly, the process may identify the new node X 516 as an invalid node. The error identification may indicate that the proposed new node X 516 has an end date which exceeds the end date 604. Corrective action may be taken such as extending the end date 604 for node A 510 to include the period 680. An alternative corrective action may be to redefine the date range 680 for the new node X 516.

The new node Y 518, is associated with a time period 690 that falls within its parent node's period of time 650. Because new node Y 518 is associated with the time period 690 which is within the period of time 650, the new node Y 518 may be identified as a valid new node.

It will be appreciated, that as the elements of the hierarchy change, maintaining the validation of the nodes included in the hierarchy may become a daunting task. While FIG. 5 shows a portion of the hierarchy 500 operating over five nodes, a strategic plan may include hundreds if not thousands of nodes each associated with respective start and end dates. The described features ensure the integrity of such a complex hierarchy is maintained in a timely and dynamic fashion.

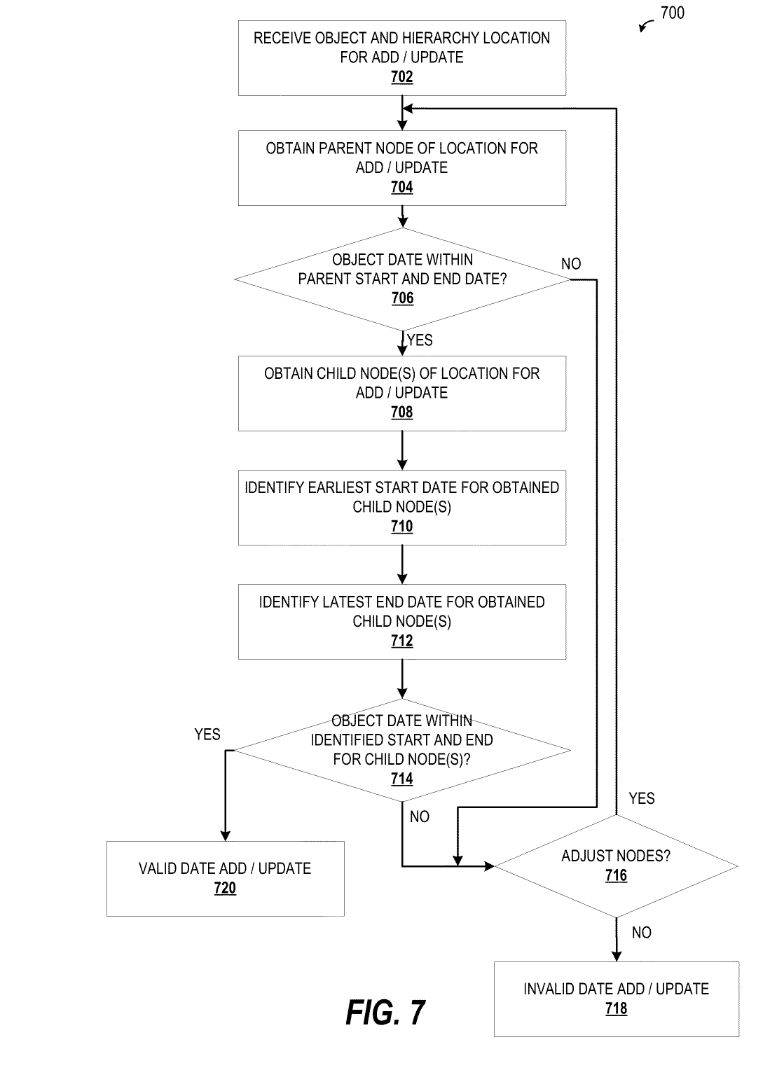

FIG. 7 shows a process flow diagram of an example method of dynamically validating the date for an object being added to or updated within a hierarchy. The process shown in FIG. 7 may be implemented in whole or in part by one of the devices described herein.

The method 700 begins at block 702. At block 702, an object and a hierarchy location for the objects addition or update are received. The object may be a goal, strategy, or an action. The hierarchy location may indicate the position within the hierarchy where the object will be added or updated. The hierarchy location may be identified using a relative location indicator or an absolute position indicator. A relative location indicator may include a parent node to which the object will be added/updated. An absolute position indicator may provide a path from the root of the hierarchy to the desired add/update location.

At block 704, parent node of the location to which the object will be added/updated is identified. The identification may include obtaining the node from memory, such as the memory 212. As the parent node has previously been validated, any children of the parent node must be within the time period associated with the parent node.

At block 706, a determination is made as to whether the object date is within the parent start date. As discussed above, if the proposed new node is outside the time period for the parent node, the desired result associated with the parent node is not achieved. Accordingly, such an object may be identified as invalid. Upon determining the object is not within the parent node start date or end date, the process 700 continues to block 716.

At block 716, a determination is made as to whether the nodes will be adjusted. The determination as to whether the nodes will be adjusted may include receiving one or more signals indicating an update to the object and or parent nodes associated with the object location. At block 718, a determination is made that the date for the object proposed to be added or updated is invalid. This determination may be included in an error message such as described in FIG. 4. Returning to block 716, if the determination is made that the nodes will be adjusted, the process 700 continues by returning to block 704.

Returning to block 706, if the proposed object is within the parent start and end date, the process 700 continues to block 708. At block 708, child nodes of the location to which the object will be added/updated are identified. As the children may identify the boundaries or include information indicating the start and/or end date, the children must also be considered. For example, if the portion of the hierarchy below the proposed add/update location is not associated with a valid date range from the perspective of the added node, the proposed addition may be identified as invalid.

Still referring to FIG. 7, having obtained a set of child nodes for consideration, at block 708, the earliest start date for the obtained child nodes is identified. The earliest start date may indicate the beginning of the time period for the desired result associated with the proposed new object. If a child node has a start date prior to the start date for the object, the child nodes will be invalid as occurring before the specified start date for the object. At block 712, the latest end date for the obtained child nodes is identified. The latest end date may indicate the termination of the time period for the desired result associated with the proposed new object.

The dates identified at blocks 710 and 712 may be used at block 714. At block 714, a determination is made as to whether the object's date is within the identified start and end date from blocks 710 and 712, respectively. If the determination is negative, the process continues to block 716 as described. If the determination is positive, the object is deemed to include a valid date range at block 720.

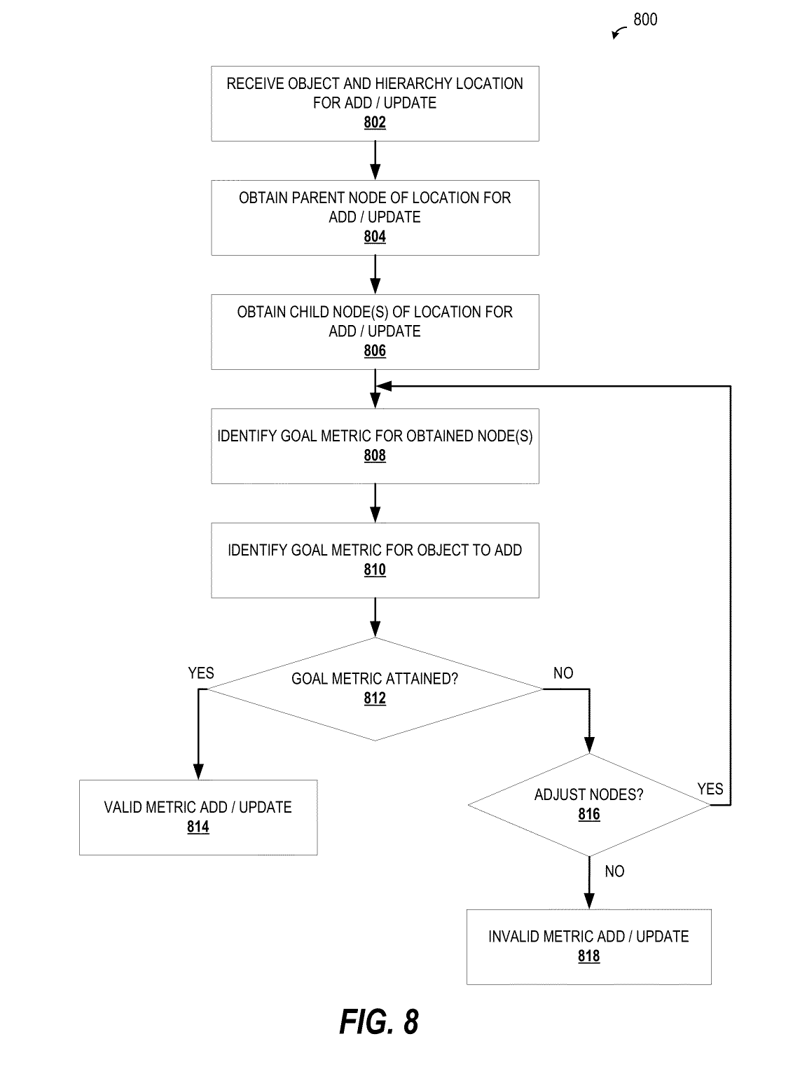

FIG. 8 shows a process flow diagram of an example method of dynamically validating the metric for an object being added to or updated within a hierarchy. The process 800 shown in FIG. 8 may be implemented in whole or in part by one of the devices described herein. The process 800 is similar to the process 700 shown in FIG. 7. However, in FIG. 8, validation of a metric is performed rather than validating a date range as an FIG. 7.

The process 800 begins at block 802. At block 802 an object in a hierarchy location for add or update is received. The hierarchy location may be indicated in relative or absolute terms as described in FIG. 7.

At block 804, the parent node of the location for add or update is obtained. Obtaining the parent node may include retrieving the parent node from a storage device, such as the memory 212 or the storage 114, based on the received hierarchy location. At block 806, child nodes of the proposed add/update location bar obtained. A child may also be retrieved from a storage device, such as the memory 212 or the storage 114, based on the received hierarchy location. In some implementations, there may be no child nodes obtained.

At block 808, a goal metric may be identified for the obtained nodes. The goal metric may indicate a maximal or minimal value. For example, a goal may maximize revenues while minimizing costs. The goal metrics obtained may be based on the metrics associated with the received object. In addition to identifying the metric type, the metric value may be obtained for each of the nodes. This may include transmitting a request for the metric value from a data source, obtaining the metric value from another node included in the hierarchy, calculating the metric value based on one or more of the above. Because these values may be obtained at or near the moment when the add/update is to occur, the integrity of the hierarchy may be maintained from moment to moment. Obtaining the goal metric may also include aggregating values from one or more nodes. For example, the total cost of a strategy may be the sum of the cost of the actions associated with the strategy.

At block 810, a goal metric is identified for the object add or update. One or more goal metrics may be identified for the object add or update. Identification of the goal metric includes identifying the goal metric type associated with the data source for the goal. Identifying the goal metric may include obtaining a metric value from an identified data source.

At block 812, a determination is made as to whether the goal metric is attained. The determination may be based on the identified goal metrics for the obtain nodes in comparison with the identified goal metric for the object add or update. For example, consider a parent node having the goal of revenues meeting or exceeding $1 million. If the added node revenue goal in conjunction with all child nodes exceeds the $1 million mark the metric is attained. If the object is being inserted such that existing nodes will become descendant nodes of the inserted object, the revenue goal for the inserted object must equal or be less than the aggregate of the child nodes. Allowing the object to be inserted such that this condition is violated would result in a logically invalid portion of the hierarchy beginning at the point of insertion.

Still referring to FIG. 8, if at block 802, a determination is made that the metric goal is achieved. The process 800 continues to block 814 where the addition or update is identified as valid. If at block 802, a determination is made that the metric goal is not achieved, the process 800 continues to block 816.

At block 816, a determination is made as to whether the nodes are to be adjusted. The determination may be based on receipt of one or more messages identifying an update or change to one or more of the parent, the child, or the object to be added. If such adjustments are identified, the process returns to block 808 for reevaluation of the goal metrics. If such adjustments are not identified at block 816, the process 800 continues to block 818 where the object add/update is identified as invalid. The identification may include providing a goal metric which has not been attained and thus led to the status of invalid.

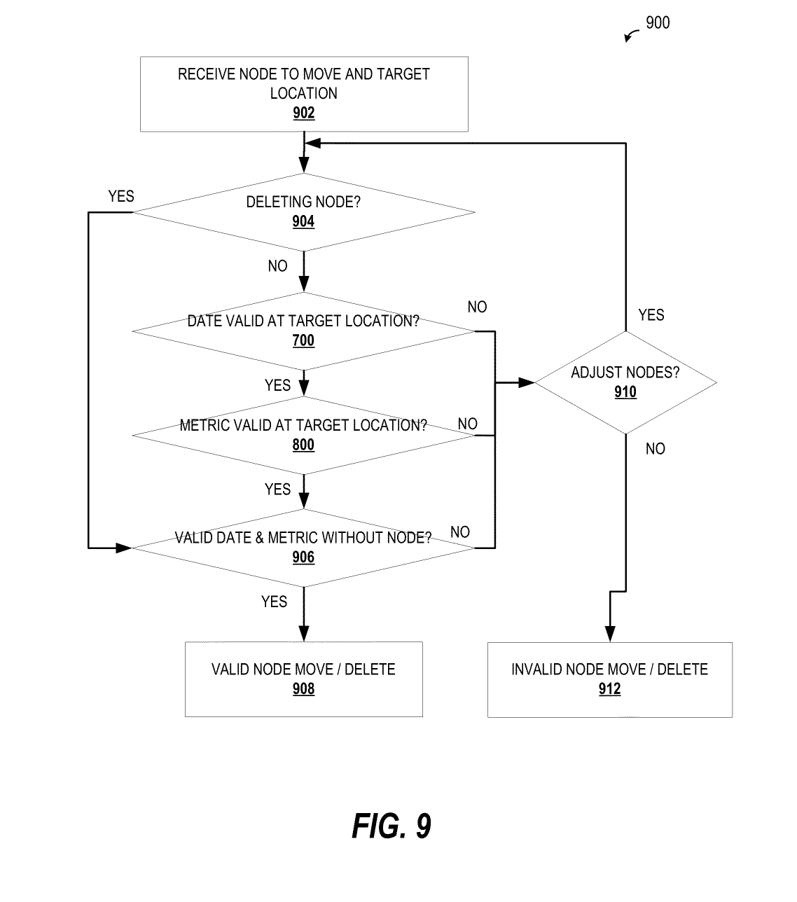

FIG. 9 shows a process flow diagram of an example method of dynamically validating a node being moved or deleted within a hierarchy. The process 900 shown in FIG. 9 may be implemented in whole or in part by one of the devices described herein.

FIG. 7 and FIG. 8 illustrate validation of date and metrics for an object to be added to hierarchy. In some implementations, it may be desirable to move a node within a hierarchy from a first location to a second location. First location may be referred to as the move location. The move location identifies the location within the hierarchy from which the move will take place. The second location may be referred to as the target location. The target location may identify the place within the hierarchy to which the object may be moved.

At block 902, the node to be moved and a target location are received. In some implementations the move location and the target location may be obtained without necessarily obtaining the entire node object. As discussed, when referring to objects within a hierarchy, the location may be specified in relative or absolute terms.

At block 904, a determination is made as to whether the node is being deleted. When deleting a node, the target location may be specified as outside the hierarchy or a predetermined “trash” location. If the determination is made that the node is being deleted, the process 900 continues to block 906. At block 906, a determination is made as to whether the hierarchy is valid, in terms of date and metrics without the node to be deleted. The determination may include identifying any child nodes from the point of deletion and ensuring the metric and date information associated with these child nodes are valid for the new parent node for the child nodes. If the determination is affirmative, the node move/delete is identified as valid at block 908.

Returning to block 906, if the determination is made that without the node, the date and metrics are invalid, at block 910, a determination is made as to whether the nodes are adjusted. The adjustment of the nodes may be similar to the adjustments performed in FIG. 7 or 8. The determination may be based on receipt of one or more messages indicating a change in the nodes which may adjust the validity of the desired action. If a determination is made that one or more nodes shall be adjusted, the process 900 returns to block 904 to reevaluate the hierarchy in view of the adjustment(s).

At block 910, if no adjustments to the nodes are identified, the process 900 continues to block 912 where the node move or delete action is identified as invalid. The identification may include information related to the goal metric or date condition which caused the determination.

Returning to block 904, if the action is not identified as a deletion of the node, the process 900 continues to block 700. Because the action is not a deletion, it can be inferred that the action is a move. Using, for example, the process 700 shown in FIG. 7, the determination at block 700 may be performed to determine whether the hierarchy is valid when the node is moved to the new location in terms of dates. If the determination is negative, the process 900 continues to block 910 as described above. If the determination at block 700 is affirmative, the process 900 continues to block 800.

At block 800, using, for example, the process 800 shown in FIG. 8, a determination is made as to whether the hierarchy is valid when the node is moved to the new location in terms of goal metrics. If the determination is negative, the process 900 continues to block 910 as described above. If the determination at block 800 is affirmative, the process 900 continues to block 906.

In the case where the action is a move, the process 900 may also include validating whether the hierarchy remains valid in the absence of the node to be moved. This is similar to a delete and block 906 performs a determination in a similar fashion as described above.

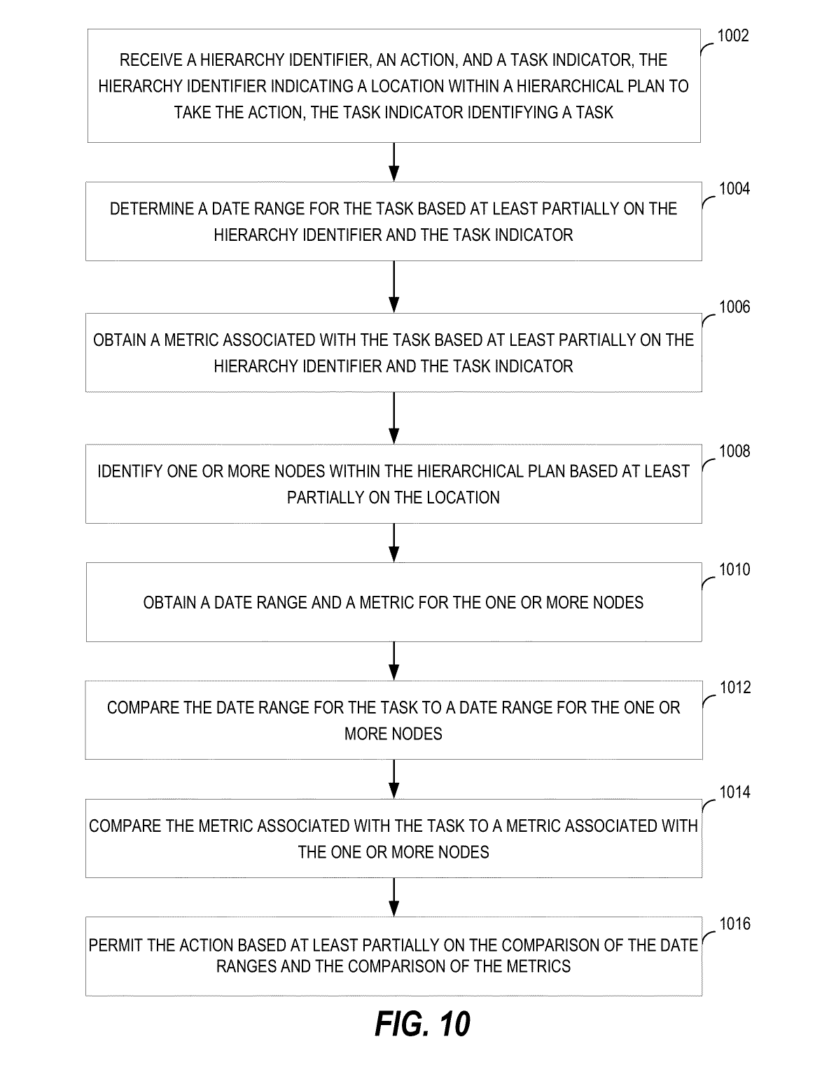

FIG. 10 illustrates a process flow diagram for a method of strategic planning. The method may be implemented in whole or in part by one or more of the devices described.

At block 1002, a hierarchy identifier, an action, and a task indicator, are received via a receiver. The hierarchy identifier indicates a location within a hierarchical plan to take the action. The task indicator identifies a task. At block 1004, a date range for the task is determined via a task information processor. The determination is based at least partially on the hierarchy identifier and the task indicator. At block 1006, a metric associated with the task is obtained from a metric data source based at least partially on the hierarchy identifier and the task indicator. At block 1008 one or more nodes within the hierarchical plan are identified based at least partially on the location. At block 1010, a date range and a metric for the one or more nodes is obtained. At block 1012, the date range for the task is compared to a date range for the one or more nodes. At block 1014, the metric associated with the task is compared to a metric associated with the one or more nodes. At block 1016, the action is permitted based at least partially on the comparison of the date ranges and the comparison of the metrics.

The terms “processor” and “processor module,” as used herein are a broad terms, and are to be given their ordinary and customary meaning to a person of ordinary skill in the art (and are not to be limited to a special or customized meaning), and refer without limitation to a computer system, state machine, processor, or the like designed to perform arithmetic or logic operations using logic circuitry that responds to and processes the basic instructions that drive a computer. In some embodiments, the terms can include ROM and/or RAM associated therewith.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “message” encompasses a wide variety of formats for transmitting information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed/transmitted/stored/received/etc. in multiple parts.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure (such as the blocks of FIGS. 1 and 2) may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by an electronic communication device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that an electronic communication device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention, e.g., as including any combination of the listed items, including single members (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Headings are included herein for reference and to aid in locating various sections. These headings are not intended to limit the scope of the concepts described with respect thereto. Such concepts may have applicability throughout the entire specification.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

What is claimed is:

1. A system for strategic planning, the system comprising:
a receiver configured to receive a message including a hierarchy identifier, an action, and a task indicator, the hierarchy identifier indicating a location within a hierarchical plan to take the action, the task indicator identifying a task;
a task information processor configured to, based at least partially on the hierarchy identifier and the task indicator:
determine a date range for the task; and
obtain a metric associated with the task;
an action validator configured to:
identify one or more nodes within the hierarchical plan based at least partially on the location;
obtain a date range and a metric for the one or more nodes;
compare the date range for the task to a date range for the one or more nodes; and
compare the metric associated with the task to the metric associated with the one or more nodes; and
a hierarchy manager configured to permit the action based at least partially on the comparison of the date ranges and the comparison of the metrics.

2. The system of claim 1, wherein the action comprises one of an add, a remove, a move, or an update for the task at the location.

3. The system of claim 1, further comprising:
a memory storing connection information associated with one or more data sources;
a transmitter configured to transmit a request for one or more values to at least one of the one or more data sources based at least partially on the stored connection information associated with the selected data sources;
the receiver configured to receive a response including the one or more values; and
a metric communication processor configured to:
identify at least one of the one or more data sources from the memory for the metric associated with the task or the metric associated with the one or more nodes;
cause the transmitter to transmit a request based at least partially on the identified data source;
obtain a response from the receiver, the response including one or more values; and
generate the metric associated with the task or the metric associated with the one or more nodes based at least partially on the received one or more values.

4. The system of claim 3, wherein the one or more data sources include one or more of the hierarchy plan, another hierarchy plan, a database, a networked information system, an electronic record, or a user interface.

5. The system of claim 1, wherein the hierarchy manager is configured to permit the action upon determining the date range for the task is within the date range for the one or more nodes.

6. The system of claim 1, wherein the metric associated with the one or more nodes comprises a growth metric, and
wherein the hierarchy manager is configured to permit the action upon determining the metric associated with the one or more nodes in combination with a corresponding growth metric for the task exceeds the growth metric associated with the one or more nodes.

7. The system of claim 1, wherein the metric associated with the one or more nodes comprises a minimization metric, and
wherein the hierarchy manager is configured to permit the action upon determining the metric associated with the one or more nodes in combination with a corresponding minimization metric for the task is less than the minimization metric associated with the one or more nodes.

8. The system of claim 1, wherein the one or more nodes include a node having a path to a root node of the hierarchy plan, the path having a length shorter than a path from the location to the root node.

9. The system of claim 1, wherein the one or more nodes include a node having a path to a root of the hierarchy plan, the path having a length greater than a path from the location to the root node.

10. The system of claim 1, wherein the hierarchy manager is configured to aggregate date ranges for a plurality of the one or more nodes to generate a comparison date range.

11. The system of claim 1, wherein the hierarchy manager is configured to aggregate at least one of:
date ranges for a portion of the one or more nodes to generate a comparison date range, or
metrics for a portion of the one or more nodes to generate a comparison metric.

12. A method of strategic planning, the method comprising:
receiving, via a receiver, a hierarchy identifier, an action, and a task indicator, the hierarchy identifier indicating a location within a hierarchical plan to take the action, the task indicator identifying a task;
determining, via a processing circuit, a date range for the task based at least partially on the hierarchy identifier and the task indicator;
obtaining a metric associated with the task from an electronic data source based at least partially on the hierarchy identifier and the task indicator;
identifying one or more nodes within the hierarchical plan based at least partially on the location;
obtaining a date range and a metric for the one or more nodes;
comparing the date range for the task to a date range for the one or more nodes;
comparing the metric associated with the task to a metric associated with the one or more nodes; and
permitting the action based at least partially on the comparison of the date ranges and the comparison of the metrics.

13. The method of claim 12, wherein the action comprises one of an add, a remove, a move, or an update for the task at the location.

14. The method of claim 12, wherein at least one of said obtaining the metric for the task or said obtaining the metric for the one or more nodes comprises:
identifying a data source for the metric associated with the task or the metric associated with the one or more nodes;
transmitting a request to the data source for one or more values;
receiving a response including the one or more values; and
generating the metric associated with the task or the metric associated with the one or more nodes based at least partially on the received one or more values.

15. The method of claim 12, wherein the action is permitted upon determining the date range for the task is within the date range for the one or more nodes.

16. The method of claim 12, wherein the metric associated with the one or more nodes is a growth metric, and
wherein the action is permitted upon determining the metric associated with the one or more nodes in combination with a corresponding growth metric for the task exceeds the growth metric associated with the one or more nodes.

17. The method of claim 12, wherein the metric associated with the one or more nodes is a minimization metric, and
wherein the action is permitted upon determining the metric associated with the one or more nodes in combination with a corresponding minimization metric for the task is less than the minimization metric associated with the one or more nodes.

18. The method of claim 12, wherein the one or more nodes include a node having a path to a root node of the hierarchy plan, the path having a length shorter than a path from the location to the root node.

19. The method of claim 12, wherein the one or more nodes include a node having a path to a root of the hierarchy plan, the path having a length greater than a path from the location to the root node.

20. The method of claim 12, further comprising aggregating date ranges for a plurality of the one or more nodes to generate a comparison date range.

21. The method of claim 12, further comprising aggregating at least one of:
date ranges for a portion of the one or more nodes to generate a comparison date range, or
metrics for a portion of the one or more nodes to generate a comparison metric.

22. The method of claim 12, wherein said obtaining a date range and said obtaining a metric for a portion of the one or more nodes is performed in parallel.

23. The method of claim 12, wherein said comparing the date range for the task to a comparison date range for the one or more nodes and said comparing the metric associated with the task to a comparison metric associated with the one or more nodes is performed in parallel.

24. A non-transitory computer readable storage medium comprising instructions executable by a processor of a device, the instructions causing the device to:
receive a hierarchy identifier, an action, and a task indicator, the hierarchy identifier indicating a location within a hierarchical plan to take the action, the task indicator identifying a task;
determine a date range for the task based at least partially on the hierarchy identifier and the task indicator;
obtain a metric associated with the task based at least partially on the hierarchy identifier and the task indicator;
identify one or more nodes within the hierarchical plan based at least partially on the location;
obtain a date range and a metric for the one or more nodes;
compare the date range for the task to a date range for the one or more nodes;
compare the metric associated with the task to a metric associated with the one or more nodes; and
permit the action based at least partially on the comparison of the date ranges and the comparison of the metrics.
